(19) United States
(12) Patent Application Publication
(10) Pub. No.: US 2013/0265519 A1
(43) Pub. Date: Oct. 10, 2013

(54) LIQUID CRYSTAL DISPLAY UNIT FOR NARROW FRAMED LIQUID CRYSTAL DISPLAY AND LIQUID CRYSTAL DISPLAY USING THE SAME

(71) Applicant: Gang Yu, Shenzhen (CN)

(72) Inventor: Gang Yu, Shenzhen (CN)

(21) Appl. No.: 13/574,741

(22) PCT Filed: Jun. 11, 2012
(86) PCT No.: PCT/CN12/76724

§ 371 Date: Jul. 23, 2012

(30) Foreign Application Priority Data
Apr. 6, 2012 (CN) 201210099418.3

(51) Int. Cl. G02F 1/1333

(52) U.S. Cl. 349/58

(57) ABSTRACT

A liquid crystal display unit for narrow framed liquid crystal display and a liquid crystal display using the liquid crystal display unit comprising a liquid crystal panel with a hole disposing on a non-display area; a middle frame with a protruding piece extended vertically to a display surface of the liquid crystal panel, the liquid crystal panel being fixed by inserting the extended protruding piece into the hole of the liquid crystal panel; and a front frame. The front frame, the liquid crystal panel and the middle frame are overlapped each other at where jointed together. The liquid crystal panel, the middle frame and a backlight unit of the narrow framed liquid crystal display are accommodated and fixed by the front frame and a back frame of the narrow framed liquid crystal display.

### FIELD OF THE INVENTION

The present invention relates to a manufacturing technique of liquid crystal display device and more particularly to a panel positioning structure for a narrow framed liquid crystal display.

### BACKGROUND OF THE INVENTION

In the recent years, thin film transistor liquid crystal display (TFT-LCD) has become the mainstream in the display market because of its characteristics of high quality picture, space-saving, low power consumption and zero radiation. TFT-LCD is mainly composed of liquid crystal display panel and backlight unit. Liquid crystal display panel and backlight unit are usually assembled together by using frames.

Conventionally, a liquid crystal display comprises a backlight unit, a liquid crystal panel and a front frame. The backlight unit has a back frame. The liquid crystal panel is disposed on the backlight unit, and the front frame and the back frame are assembled together in order to fix the liquid crystal panel. Generally, the fastening parts are disposed on the front frame and the back frame, respectively. The liquid crystal panel and the backlight unit are assembled together by the fastening part of the front frame engaged with the fastening part of the back frame. In the conventional assembling techniques, the liquid crystal panel and the backlight unit are fixed by the fastening part of the front frame and the back frame.

In the conventional techniques, the structural strength of the liquid crystal display depends on the engaging strength of the fastening part of the front frame and the back frame. Even though the liquid crystal display can be structurally strengthened against impact by increasing the engaging area between the fastening part of the front frame and the back frame, the sizes of the fastening part of the front frame and the back frame are limited by the demand of narrow frame design of the liquid crystal display. Therefore, a technique for securely assembling the liquid crystal panel in the liquid crystal display is demanded.

### SUMMARY OF THE INVENTION

An objective of the present invention is to provide a liquid crystal display unit for narrow framed liquid crystal display and a liquid crystal display using the liquid crystal display unit to overcome the drawbacks of the conventional technique. The present invention provides a protruding piece disposed on a supporting surface of a middle frame and fitted with a hole of the liquid crystal panel for securing the position of a liquid crystal panel. Thereby, the objectives of narrow frame design and secure positioning can be achieved by the present invention.

A technical solution provided by the present invention to overcome the above technical problems includes a liquid crystal display unit for narrow framed liquid crystal display and a liquid crystal display using the same. The liquid crystal display unit for narrow framed liquid crystal display and the liquid crystal display using the same comprising a liquid crystal panel with a hole forming on a non-display area; a middle frame with a protruding piece extended vertically to a display surface of the liquid crystal panel, the liquid crystal panel being fixed by inserting the extended protruding piece into the hole of the liquid crystal panel; and a front frame having a hollow rectangular frame structure. The front frame, the liquid crystal panel and the middle frame are overlapped each other at where they are jointed together. The liquid crystal panel, the middle frame and a backlight unit of the narrow framed liquid crystal display are accommodated and fixed by the front frame and a back frame of the narrow framed liquid crystal display.

In an embodiment of the present invention, the hole of the liquid crystal panel is a blind hole.

In an embodiment of the present invention, the hole of the liquid crystal panel is a through hole.

In an embodiment of the present invention, the middle frame further comprises a supporting surface.

In an embodiment of the present invention, the protruding piece is disposed on the supporting surface and the middle frame is integrally formed.

In an embodiment of the present invention, the protruding piece is a metal column disposing on the supporting surface and is inserted into the middle frame.

In an embodiment of the present invention, the hole of the liquid crystal panel is fitted with the protruding piece of the middle frame so that the liquid crystal panel is superimposed on the supporting surface of the middle frame, and the front frame is superimposed on the non-display area of the liquid crystal panel, Therefore, the front frame, the liquid crystal panel and the middle frame are overlapped each other at where they are jointed together.

In an embodiment of the present invention, the front frame has a hollow rectangular frame structure.

Comparing the conventional techniques with the present invention, by employing the protruding piece of the middle frame and the blind or through hole disposed near an edge of the liquid crystal panel, the length of the front frame superimposed on the liquid crystal panel can be reduced effectively by inserting the protruding piece into the hole on the non-display area of the edge of the liquid crystal panel. Thereby, the objective of narrow frame design can be achieved and the problem of reduced dependability because of an overlapped length between the liquid crystal panel and the front frame is too short can be prevented.

### BRIEF DESCRIPTION OF THE DRAWINGS

FIG. 1 is an exploded view of a liquid crystal display according to a first embodiment of the present invention;

FIG. 2 is a sectional view of the liquid crystal display according to the first embodiment of the present invention;

FIG. 3 is an exploded view of the liquid crystal display according to a second embodiment of the present invention; and

FIG. 4 is a sectional view of the liquid crystal display according to the second embodiment of the present invention.

### DETAILED DESCRIPTION OF THE INVENTION

The present invention will become more fully understood by reference to the following detailed description thereof when read in conjunction with the attached drawings.

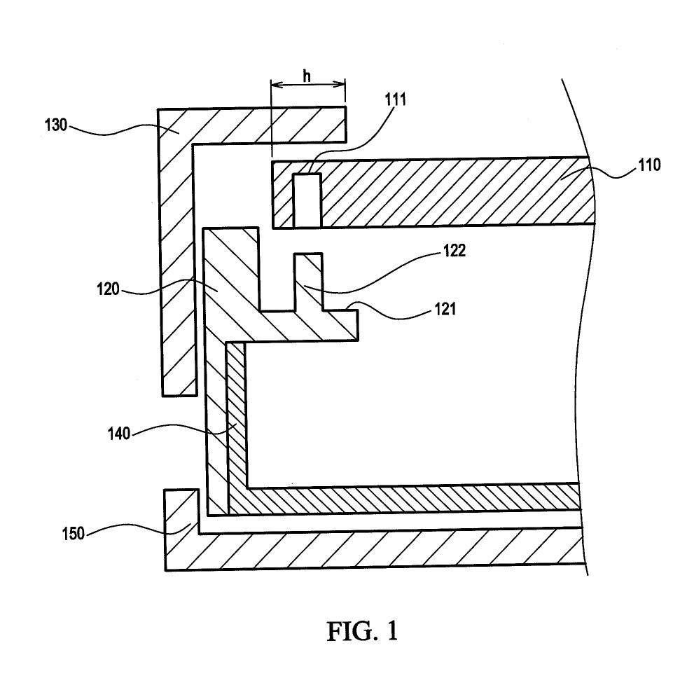

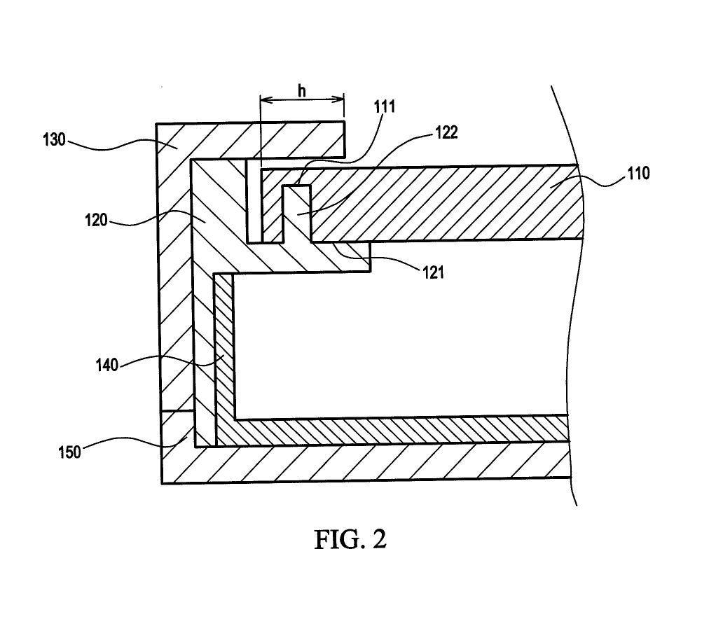

Please refer to FIGS. 1 and 2. A panel positioning structure for a narrow framed liquid crystal display of a first embodiment of the present invention comprises a liquid crystal panel 110 with a hole 111 forming on a non-display area, a middle frame 120 comprising a supporting surface 121; a protruding piece 122 being disposed on the supporting surface 121, the protruding piece 122 being extended vertically to a display surface of the liquid crystal panel 110, the liquid crystal panel 110 being fixed by inserting the extended protruding piece 122 into the hole 111 of the liquid crystal panel 110; and a front frame 130 having a hollow rectangular frame structure, wherein the front frame 130, the liquid crystal panel 110 and the middle frame 120 are overlapped each other at where they are jointed together, the liquid crystal panel 110, the middle frame 120 and a backlight unit 140 of the narrow framed liquid crystal display are accommodated and fixed by the front frame 130 and a back frame 150 of the narrow framed liquid crystal display.

The present invention provides the protruding piece 122 formed on the supporting surface 121 of the middle frame 120 and the hole 111 of the liquid crystal panel 110. The hole 111 can be a blind hole or a through hole. For example, the hole 111 of the embodiment is a blind hole, and the protruding piece 122 and the hole 111 are disposed in corresponding to each other. In assembling, the protruding piece 122 and the hole 111 are fitted together, and the front frame 130 is superimposed on the non-display area of the liquid crystal panel 110 for securing the liquid crystal panel 110, such that it prevent to produce the problem of reduced dependability which an overlapped length h between the liquid crystal panel 110 and the front frame 130 is too short. FIG. 2 shows that the protruding piece 122 of the middle frame 120 and the hole 111 of the liquid crystal panel 110 are assembled together.

Thereby, in the assembling of the narrow framed liquid crystal display, the drawback of the conventional technique which changes the engaging strength of a fastening part can be overcome. Conventionally, the enhancement of the limited sizes of the fastening parts is limited, so it still has an issue how to fix the liquid crystal panel in the liquid crystal display.

Comparing with the conventional techniques, the liquid crystal display and its liquid crystal display unit of the present invention are favorable for assembling and can also meet the requirements for narrow frame design. Besides the liquid crystal display, the structural design of the present invention can also be employed in other flat displays. Generally, all flat displays comprise an outer case and a panel unit. The panel unit is disposed inside the outer case. The panel unit comprises a front frame, a back frame and a display panel. The front frame and the back frame are connected with each other to cover the display panel partially. Based on the previous embodiment, at least one protruding piece can be disposed on the back frame and a plurality of holes can be disposed on a non-display area of the display panel. The protruding piece and the hole are fitted together. Thereby, the thickness of the frame of the flat display does not have to be increased, and the dependability of the display panel and the front frame can be enhanced.

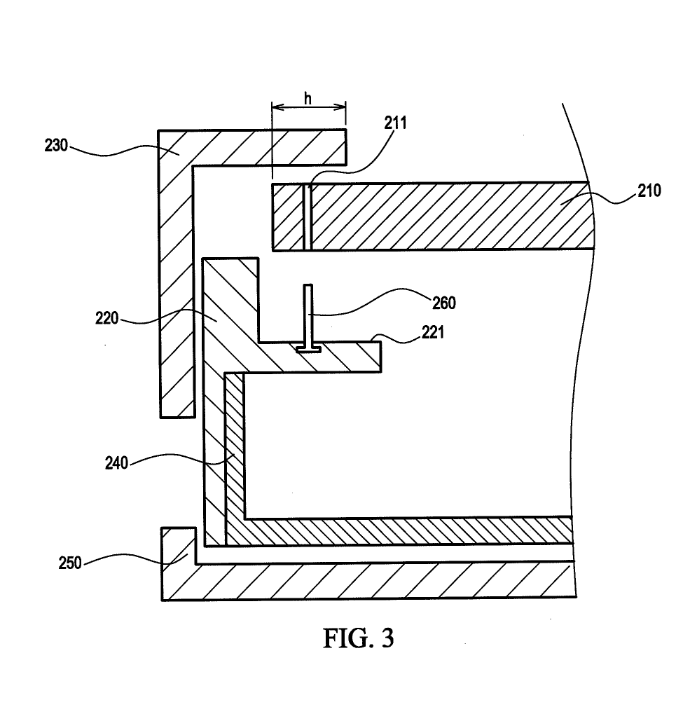

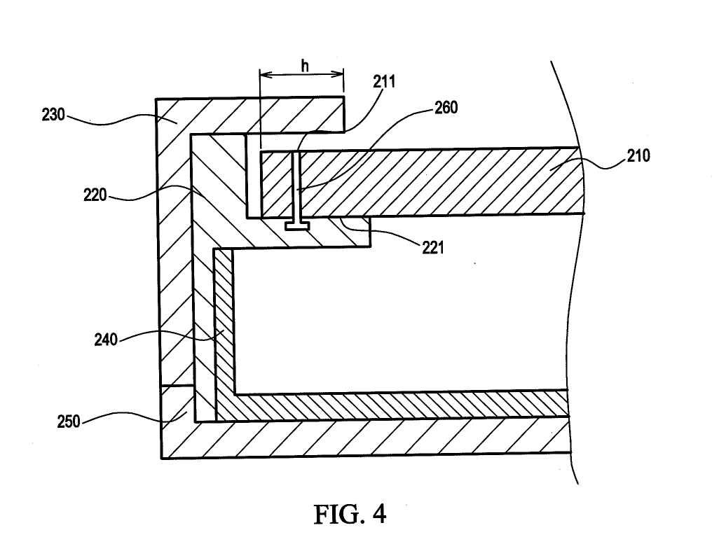

FIGS. 3 and 4 are an exploded view and a sectional view of the panel positioning structure for the narrow framed liquid crystal display of a second embodiment of the present invention respectively. In order that the circuit design on a liquid crystal panel 210 is less hindered, a hole 211 on a non-display area of the liquid crystal panel 210 is made smaller; a metal column 260 is inserted into a supporting surface 221 of a middle frame 220 when the middle frame 220 is formed by injection molding. After the hole 211 disposed on the non-display area of the liquid crystal panel 210 and the metal column 260 of the middle frame 220 are fitted together, the metal column 260 can offer enough positioning strength. Thereby, narrow frame design for a front frame 230 can be achieved and the liquid crystal panel 210 can be positioned more securely.

Note that the specifications relating to the above embodiments should be construed as exemplary rather than as limitative of the present invention, with many variations and modifications being readily attainable by a person of average skill in the art without departing from the spirit or scope thereof as defined by the appended claims and their legal equivalents.

What is claimed is:

1. A liquid crystal display unit for a narrow frame liquid crystal display comprising:
a liquid crystal panel with a hole forming on a non-display area, and the hole being a blind hole or a through hole ;
a middle frame with a protruding piece disposing on the middle frame, the protruding piece being extended vertically to a display surface of the liquid crystal panel, the liquid crystal panel being fixed by inserting the extended protruding piece into the hole of the liquid crystal panel, the middle frame further comprising a supporting surface, the protruding piece being disposed on the supporting surface, the supporting surface and the middle being integrally formed, the protruding piece being a metal column disposing on the supporting surface and is inserted into the middle frame; and
a front frame, wherein the front frame, the liquid crystal panel and the middle frame are overlapped each other at where jointed together, the liquid crystal panel, the middle frame and a backlight unit of the narrow framed liquid crystal display are accommodated and fixed by the front frame and a back frame of the narrow framed liquid crystal display, the front frame has a hollow rectangular frame structure;
wherein the hole of the liquid crystal panel is fitted with the protruding piece of the middle frame so that the liquid crystal panel is superimposed on the supporting surface of the middle frame, the front frame is superimposed on the non-display area of the liquid crystal panel, and the front frame, the liquid crystal panel and the middle frame are overlapped each other at where jointed together.

2. A liquid crystal display unit for a narrow frame liquid crystal display comprising:
a liquid crystal panel with a hole forming on a non-display area;
a middle frame with a protruding piece disposing on the middle frame, the protruding piece being extended vertically to a display surface of the liquid crystal panel, the liquid crystal panel being fixed by inserting the extended protruding piece into the hole of the liquid crystal panel; and
a front frame, wherein the front frame, the liquid crystal panel and the middle frame are overlapped each other at where jointed together, the liquid crystal panel, the middle frame and a backlight unit of the narrow framed liquid crystal display are accommodated and fixed by the front frame and a back frame of the narrow framed liquid crystal display.

3. The liquid crystal display unit for a narrow frame liquid crystal display of claim 2, wherein the hole of the liquid crystal panel is a blind hole.

4. The liquid crystal display unit for a narrow frame liquid crystal display of claim 2, wherein the hole of the liquid crystal panel is a through hole.

5. The liquid crystal display unit as claimed for a narrow frame liquid crystal display of claim 2, wherein the middle frame further comprises a supporting surface.

6. The liquid crystal display unit for a narrow frame liquid crystal display of claim 5, wherein the protruding piece is disposed on the supporting surface and the middle frame is integrally formed.

7. The liquid crystal display unit for a narrow frame liquid crystal display of claim 5, wherein the protruding piece is a metal column disposing on the supporting surface and is inserted into the middle frame.

8. The liquid crystal display unit for a narrow frame liquid crystal display of claim 5, wherein the hole of the liquid crystal panel is fitted with the protruding piece of the middle frame so that the liquid crystal panel is superimposed on the supporting surface of the middle frame, the front frame is superimposed on the non-display area of the liquid crystal panel, and the front frame, the liquid crystal panel and the middle frame are overlapped each other at where jointed together.

9. The liquid crystal display unit for a narrow frame liquid crystal display of claim 2, wherein the front frame has a hollow rectangular frame structure.

10. A liquid crystal display comprising a liquid crystal display unit, a backlight unit and a back frame, the liquid crystal display unit comprising:
a liquid crystal panel with a hole disposing on a non-display area;
a middle frame comprising a supporting surface, a protruding piece being disposed on the supporting surface, the protruding piece being extended vertically to a display surface of the liquid crystal panel, the liquid crystal panel being fixed by inserting the extended protruding piece into the hole of the liquid crystal panel; and
a front frame having a hollow rectangular frame structure, the front frame, the liquid crystal panel and the middle frame being overlapped each other at where jointed together, the liquid crystal panel, the middle frame and the backlight unit being accommodated and fixed by the front frame and the back frame.

11. The liquid crystal display of claim 10, wherein the hole of the liquid crystal panel is fitted with the protruding piece of the middle frame so that the liquid crystal panel is superimposed on the supporting surface of the middle frame, the front frame is superimposed on the non-display area of the liquid crystal panel, and the front frame, the liquid crystal panel and the middle frame are overlapped each other at where jointed together.
